(19) United States
(12) Patent Application Publication
(10) Pub. No.: US 2026/0340299 A1
(43) Pub. Date: Oct. 29, 2026

(54) SUMMARIZING CONVERSATIONS WITH AGENTIC AGENTS

(71) Applicant: Dell Products L.P., Round Rock, TX (US)

(72) Inventors: OFIR EZRIELEV, Be'er Sheva (IL); YEHIEL ZOHAR, Sderot (IL); HANNA YEHUDA, Acton, MA (US)

(21) Appl. No.: 19/192,521

(22) Filed: Apr. 29, 2025

(51) Int. Cl. G06F 40/35; G06F 16/34

(52) U.S. Cl. CPC G06F 40/35; G06F 16/345

(57) ABSTRACT

Methods and systems for managing operation of infrastructure are provided. To manage the infrastructure, agentic agents may be deployed. The deployed agentic agents may be customized prior to deployment and interact with users of the infrastructure via a conversation or other type of interface to attempt to infer intents of the users with respect to computer implemented services provided by the infrastructure. A summarization may be generated for at least a portion of the conversation based on content of the conversation, disagreements between the agentic agents, different viewpoints of the agentic agents, and/or other qualities of the conversation. The summarization may be used to solicit feedback from the client to refine the intents of the users.

### FIELD

Embodiments disclosed herein relate generally to infrastructure. More particularly, embodiments disclosed herein relate to systems and methods to manage infrastructure using agentic agents.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-1F show data flow diagrams illustrating processing and use of data in accordance with an embodiment.

FIGS. 2A-2E show diagrams illustrating examples of user interfaces in accordance with an embodiment.

FIG. 3 shows a flow diagram illustrating a method in accordance with an embodiment.

FIG. 4 shows a block diagram illustrating a data processing system in accordance with an embodiment.

### DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of infrastructure. To manage the infrastructure, agentic agents may be deployed and tasked with managing the infrastructure to effectuate the desired intents of users of the infrastructure.

The agentic agents may be customized for different domains. Once customized, users may initiate communications with the agentic agents using a chat interface. The chat interface may be used to convey the intents to the agentic agents. Different agentic agents may be customized to different domains and, therefore, may have access to different types of information, reasoning processes, etc. Accordingly, the agentic agents may generate different responses to chats by the users.

The chat interface may be used to obtain information regarding intents of the user, confirm the intents of the users, and/or align future management activities of the agentic agents with the user intents.

To improve a likelihood that the different responses may be used to obtain the information regarding an intent of the user, the different responses may be summarized based on content of the responses, at least one disagreement between the different responses, different viewpoints of the agentic agents, and/or any other methods. Using the summarization, user feedback may be obtained to refine an understanding of the intent of the user.

By doing so, embodiments disclosed herein may improve the likelihood of services provided by infrastructure being deemed to be desirable by the users. Thus, embodiments discussed herein may address, among others, the technical problem of intent and expectation mismatch between users of infrastructure and the managers of the infrastructure.

In an embodiment, a method for managing infrastructure that provides desired computer implemented services is provided. The method may include (i) obtaining, using a chat interface, a conversation between a client and a plurality of agentic agents, the agentic agents being adapted to manage the infrastructure on behalf of the client; (ii) generating a summarization of at least a portion of the conversation, the summarization distinguishing different viewpoints of the agentic agents in the conversation; (iii) using the summarization to solicit feedback from the client to refine an understanding of intent of the client with respect to future operation of the infrastructure; and using the refined understanding of the intent of the client to update operation of the infrastructure to facilitate continued provisioning of the desired computer implemented services.

The method may also include: (i) prior to generating the summarization: (a) obtaining user input from the client indicating a request to change a mode of the chat interface to a summarization mode, the user input comprising a button selection.

Using the summarization may include: (i) providing, while in the summarization mode, the different viewpoints indicated using a range element; and (ii) obtaining the feedback from the client using the range element, the feedback comprising a selection on the range element corresponding to relative agreement with one viewpoint of the different viewpoints.

Generating the summarization may include summarizing at least a portion of content of the conversation, the content being the portion of the conversation displayed in a current view of the chat interface.

Generating the summarization may include summarizing at least one disagreement between the agentic agents in the conversation.

Generating the summarization may include summarizing the different viewpoints of the agentic agents with respect to at least one topic of the conversation.

Using the summarization may include generating a tacit statement based on the feedback from the client, the tacit statement being a partial but incomplete statement of the intent of the client.

Using the refined understanding may include: (i) inferring the intent of the client using, at least, the tacit statement and another tacit statement derived from the client; (ii) identifying at least one difference between current operation of the infrastructure and the inferred intent of the client; (iii) selecting at least one action based on the at least one different, the at least one action being selected to at least mitigate the at least one difference; and (iv) performing the at least one action to update the operation of the infrastructure.

The agentic agents may be customized versions of trained agents, each version of the customized versions being trained using a different data set.

The agentic agents may be trained for different domains using different data sets, a viewpoint of an agentic agent of the agentic agents being based on a domain of the different domains for which the agentic agent is trained.

In an embodiment, a non-transitory media is provided that may include instructions that when executed by a processor cause any of the above noted method to be performed.

In an embodiment, a system is provided that may include the non-transitory media and a processor, and may perform any of the above noted method when the computer-instructions are executed by the processor.

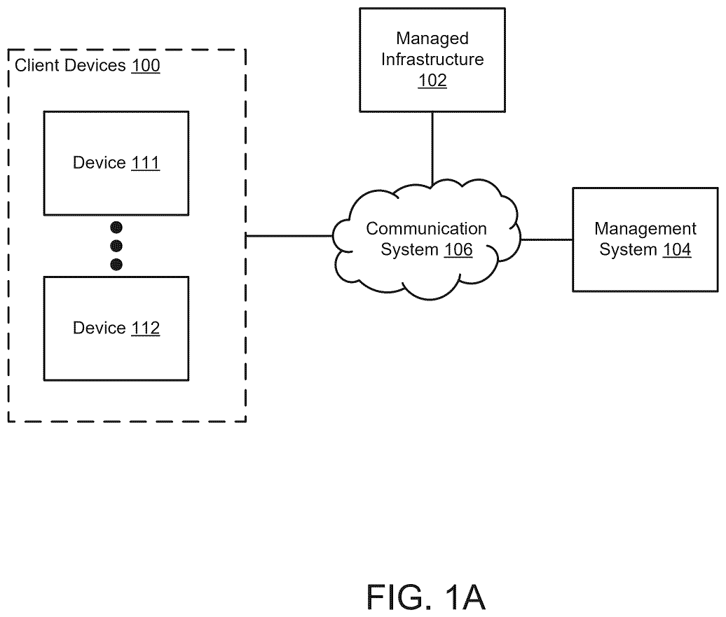

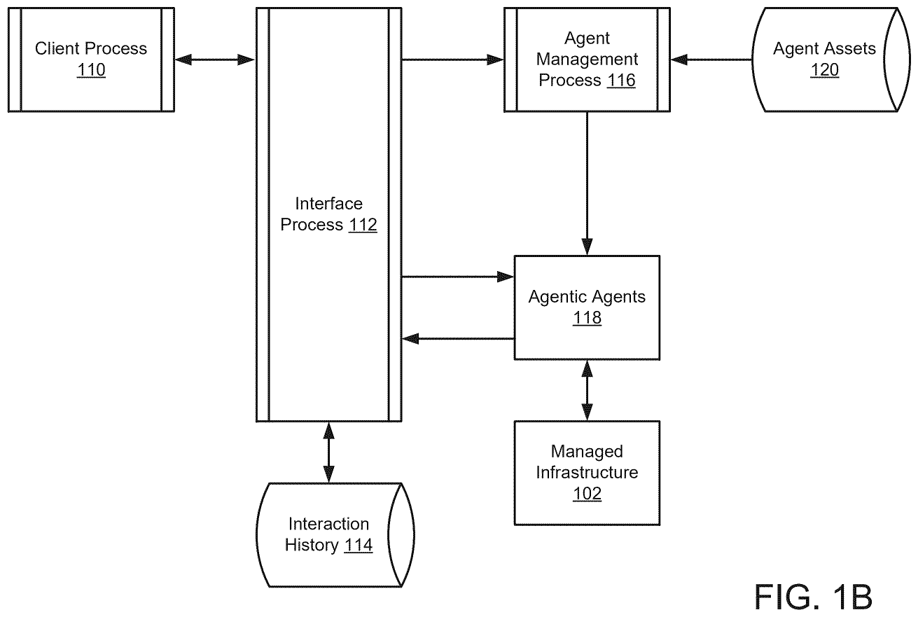

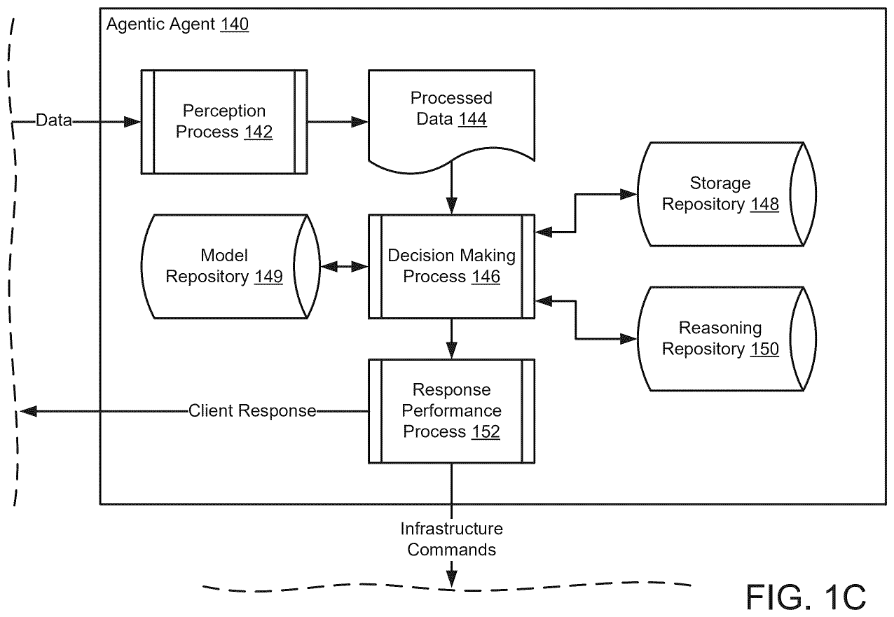

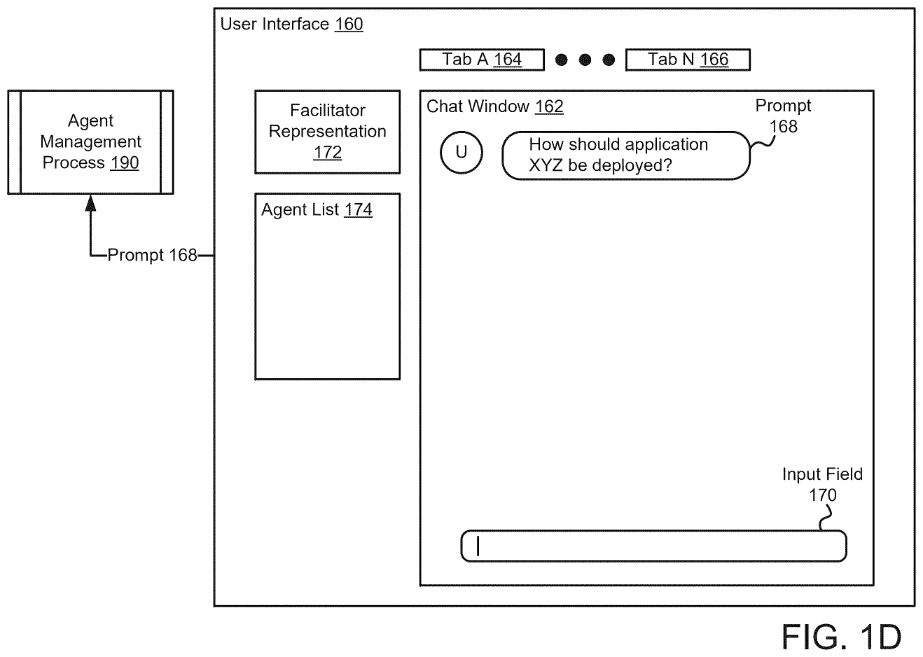

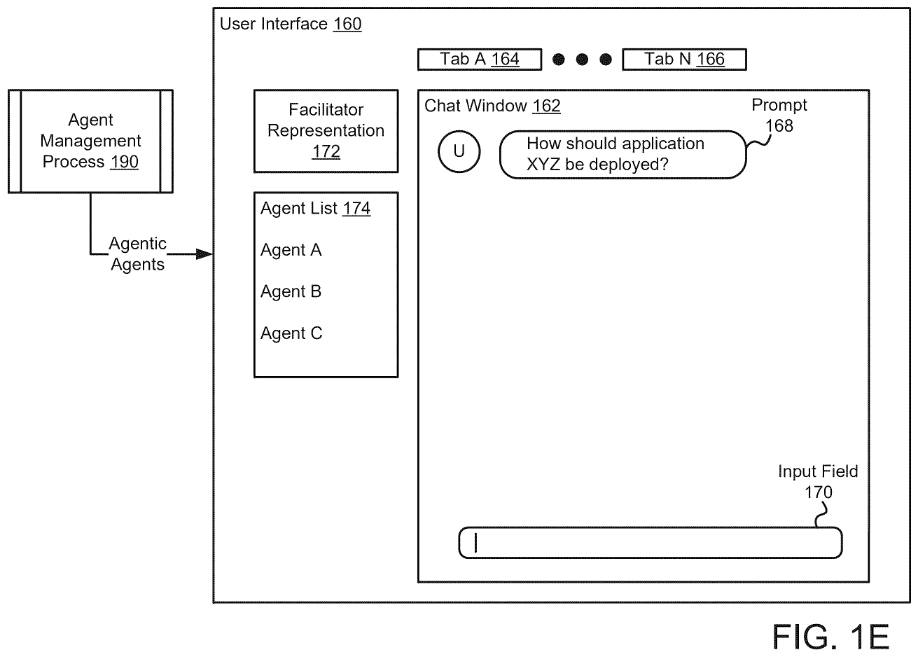

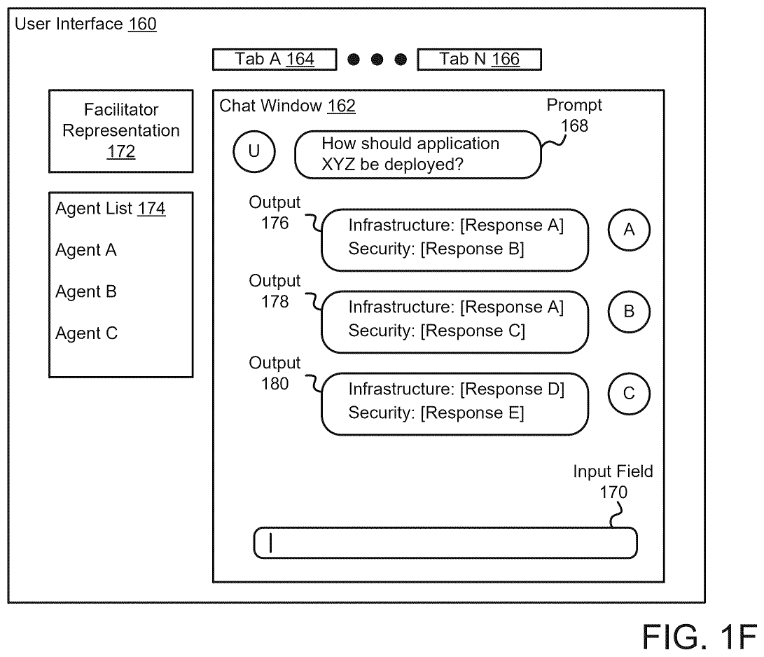

Turning to FIG. 1A, a block diagram of a system in accordance with an embodiment is shown. The system may provide any number and type of computer implemented services.

The computer implemented services may include, for example, database services, data processing services, communications, and/or other types of services. Any of the components of the system of FIG. 1A may provide all, or a portion, of the computer implemented services independently and/or in cooperation with other components of the system.

For the computer implemented services provided by the system of FIG. 1A to be deemed to be desirable by users (e.g., computer programs, persons, etc.) of the computer implemented services, the computer implemented services may need to meet various requirements (e.g., timeliness, accuracy, cost, etc.) and may need to be provided in certain manners (e.g., complete objectives). These requirements and manners may be indicated, for example, by users of the computer implemented services.

To ensure that the computer implemented services meet the requirements and manners of provisioning so that they are (or at least more likely to be) deemed to be desirable, the system of FIG. 1A may configure itself in a corresponding manner. For example, various pieces of software may be deployed, configurations of the software and/or hardware components may be set, various resources of the system may be reserved for contributing to the services, etc.

However, if the aforementioned configuration of the system of FIG. 1A is not successfully completed, then the computer implemented services may be more likely to be deemed to be undesirable. For example, if insufficient resources for providing the computer implemented services are reserved, then the provided computer implemented services may not meet timeliness (e.g., latency) goals. Other issues may impact the computer implemented services if the aforementioned configuration of the system of FIG. 1A is not successfully completed without departing from embodiments disclosed herein.

Further, a mismatch between an intent of the users regarding the computer implemented services and an understanding of the intent by the system of FIG. 1A may also reduce the likelihood of the computer implemented services being deemed to be desirable. For example, if a user only partially conveys an intent by making a tacit statement (e.g., a partial but incomplete statement of intent) regarding the computer implemented services to be provided, then the system may not successfully deploy a corresponding configuration necessary to provide the computer implemented services in a manner that meets that actual intent of the users.

Additionally, if a mismatch between an understanding of the users regarding future operation of the system of FIG. 1A and the actual likely future operation of the system may further reduce the likelihood of the computer implemented services being deemed to be desirable. For example, the users may have limited knowledge regarding how configurations of the system are likely to impact the provided computer implemented services. Consequently, even if informed of a configuration for the system (e.g., in scenarios where users or other persons establish the configuration), the users may incorrectly identify how the computer implemented services will be provided under that configuration (e.g., the users may expect the computer implemented services to meet different requirements and/or be provided in different manners). Accordingly, the actual computer implemented services may be less likely to meet the users'expectations thereby causing the actually provided computer implemented services to be less likely to be deemed to be desirable.

In general, embodiments disclosed herein relate to systems, methods, and devices for improving the likelihood of computer implemented services provided by systems meeting the expectations of requestors of the services (e.g., being deemed to be desirable). To improve the likelihood of the computer implemented services being deemed to be desirable, an agentic agent based framework may be used to manage the operation of the system. The agentic agent framework may facilitate (i) domain customization and deployment of domain customized agentic agents, (ii) chat based interactions between the domain customized agentic agents and users of the system, (iii) user intent identification and confirmation for the computer implemented services, (iv) cooperative analysis and decision making among the agentic agents, and/or (v) management of infrastructure by the domain customized agentic agents.

By doing so, embodiments disclosed herein may improve the likelihood of computer implemented services provided by a system being deemed desirable by the users for which the services are provided. Thus, embodiments disclosed herein may address, among others, the technical problems of (i) misinterpretation of requests and/or intent in distributed system, (ii) limited technical knowledge of users of the system that may preclude (or limit the ability of) the users from making configuration decisions that are likely to effectuate their intent, and (iii) system configuration drift that may preclude (or limit the ability of) the system to provide desirable computer implemented services.

To provide the above noted functionality, the system may include any number of client devices 100, managed infrastructure 102, management system 104, and communication system 106. Each of these components is discussed below.

Client devices 100 may be used by users (e.g., employees of a business, administrators, computer programs hosted by client devices 100, etc.) to manage and/or obtain computer implemented services provided by/from managed infrastructure 102. To do so, client devices 100 may host interfaces usable to communicate with managed infrastructure 102 and/or management system 104. For example, the interfaces may include chat interfaces through which chat sessions managed by management system 104 may be reached by the users. Client devices may include any number of such devices (e.g., 111, 112) used by any number of users.

Managed infrastructure 102 may provide computer implemented services. To provide the computer implemented services, managed infrastructure 102 may host automation frameworks usable to deploy software, manage configurations of software/hardware components, and/or otherwise modify the operation of various portions of managed infrastructure 102. All, or a portion, of the functionality of the automation frameworks may be usable by agentic agents managed by management system 104.

The agentic agents may be tasked with (i) collecting information from managed infrastructure 102 (e.g., state information, telemetry, etc.), (ii) interacting with users via the chat sessions, (iii) inferring intents of the users regarding computer implemented services to be provided by managed infrastructure 102, and (iv) modifying the operation of managed infrastructure 102 over time to attempt to effectuate the inferred intents.

Because the chat sessions may be an incomplete description of the intent of the users, information obtained by the chat sessions from the users may be treated as tacit statements (e.g., partial statements that may not be a complete declaration of an intent, may be in conflict with other tacit statements, etc.). The tacit statements may be used to infer the intent of the user over time (e.g., which may update as additional tacit statements are obtained). The inferred intent of the users may then be used to identify a goal state for operation of managed infrastructure 102. Once identified, the goal state may be used to select actions to be performed to modify the operation of managed infrastructure 102 to align the actual state of managed infrastructure 102 with the goal state (e.g., over time).

As part of inferring of the intents of the users, information regarding the actual state of managed infrastructure 102 may also be taken into account. Thus, changes in the actual state of managed infrastructure 102 (e.g., changes in hardware components, changes in deployed software, changes in configurations, changes in conditions impacting managed infrastructure 102, etc.) may also change the inferred intents of the users.

To identify the actions to be performed, a quantification process regarding the intent may be performed. For example, an objective function may be formed and used to evaluate the impact of performance of different actions to modify the state of managed infrastructure 102. In an example, the objective function may be formed using key performance indicators (e.g., service latency, resiliency to cyberthreats, cost of operation, etc.) from the inferred intents. These key performance indicators may be compared to actual key performance indicators of the distributed system to identify the degree (e.g., which may be quantified by the objective function) to which the intents of the users are being effectuated by managed infrastructure 102.

Over time, the agentic agents may select actions to perform on the basis of attempting to maximize the degree to which the tents of the users are being effectuated by the actual operation of managed infrastructure 102.

Management system 104 may manage the agentic agents in the system. To manage the agentic agents, management system 104 may (i) customize and deploy domain customized agentic agents to facilitate management of managed infrastructure 102 and (ii) manage chat sessions to facilitate interactions between users and the domain customized agentic agents to (a) infer intents of the users, (b) inform the users of likely impacts for different potential changes in configuration of managed infrastructure 102, and/or (c) otherwise facilitate management of managed infrastructure 102.

When providing their functionality, client devices 100, managed infrastructure 102, and/or management system 104 may perform all, or a portion, of the flows and/or methods shown in FIGS. 1B-3.

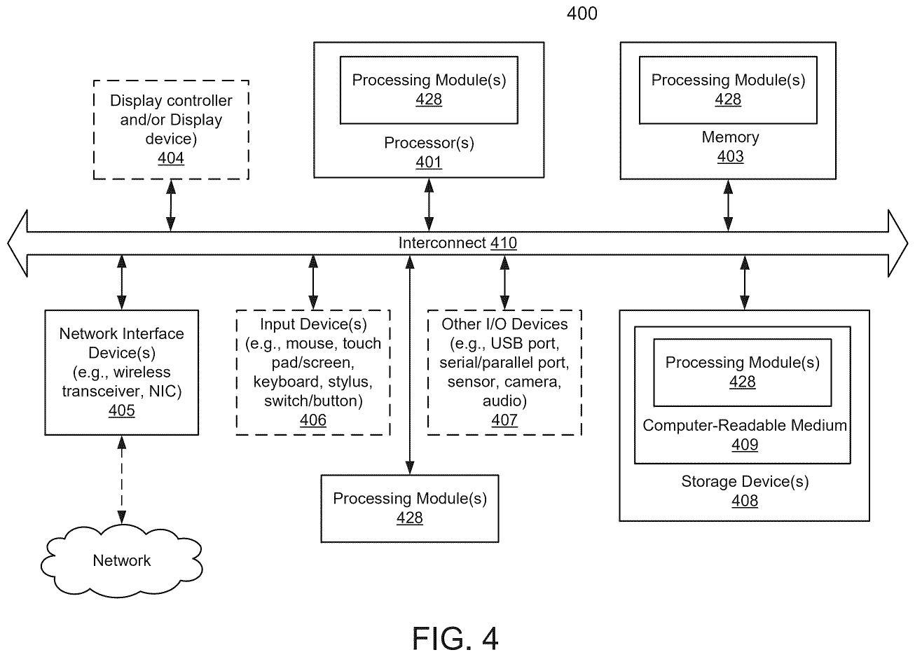

Any of the devices (and/or components thereof) included in the system shown in FIG. 1A may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with a communication system (e.g., 106). In an embodiment, this communication system includes one or more networks that facilitate communication between any number of components (e.g., including others not shown in FIG. 1A). The networks may include wired networks and/or wireless networks (e.g., and/or the Internet). The networks may operate in accordance with any number and types of communication protocols (e.g., such as the internet protocol).

While illustrated in FIG. 1A as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 1B-1F. These data flow diagrams may illustrate how data may be obtained and used within the system of FIG. 1A.

In the data flow diagrams, flows of data and processing of data are illustrated using different sets of shapes. In the context of these data flow diagrams, a first set of shapes (e.g., 144, 200, etc.) is used to represent data structures, a second set of shapes (e.g., 110, 112, etc.) is used to represent processes performed using and/or that generate data, and a third set of shapes (e.g., 114, 120, etc.) is used to represent large scale data structures such as databases.

Turning to FIG. 1B, a first data flow diagram in accordance with an embodiment is shown. The first data flow diagram may illustrate data used in and data processing performed in management of managed infrastructure.

To manage the managed infrastructure, a user may use a client device to perform client process 110. During client process 110, a management request may be sent to the management system. Based on the request, the management system may initiate performance of interface process 112.

During interface process 112, a chat session between the user and the management system may be initiated. The corresponding client process (e.g., 110) may obtain user input and direct it to the chat session managed by interface process 112. Refer to FIGS. 1D-1F for additional information regarding how the chat session may be performed.

During the chat session, information may be conveyed by the user regarding a goal, desire, requirements, and/or other characteristic of computer implemented services to be provided by managed infrastructure 102. The information may be used to identify (i) new agentic agents to be instantiated to assist in accomplishing the intent of the users, and/or (ii) new and/or existing agents to invite to chat session. The agents may be identified, for example, based on a prompt or other information provided by the users. Once identified, the agentic agents may participate in the corresponding chat session.

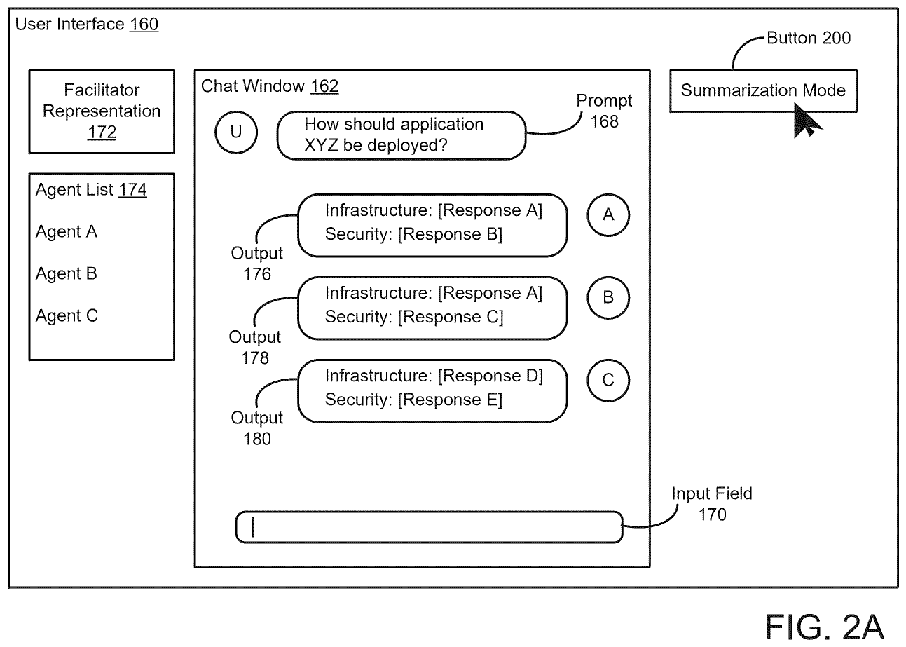

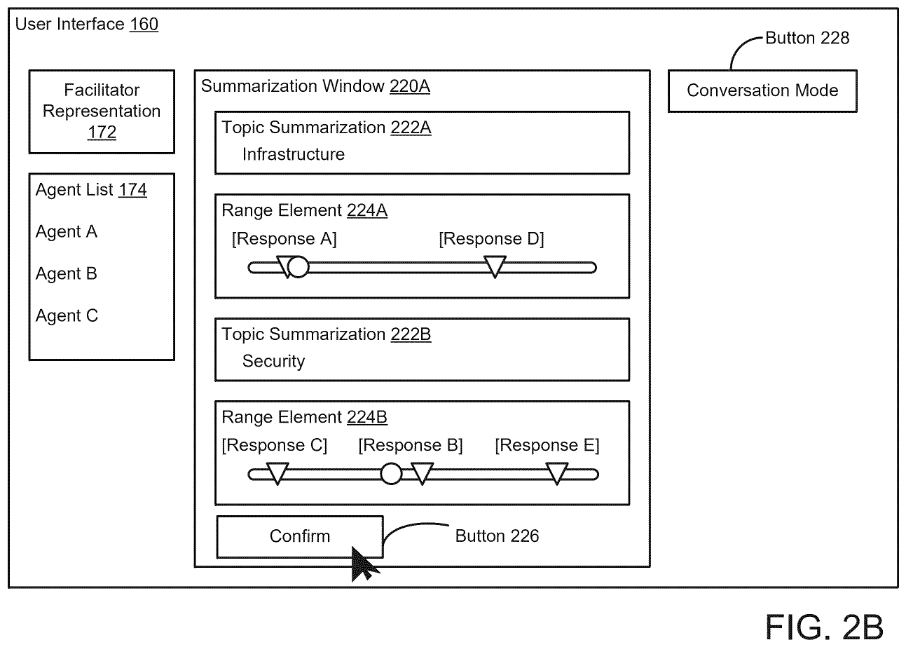

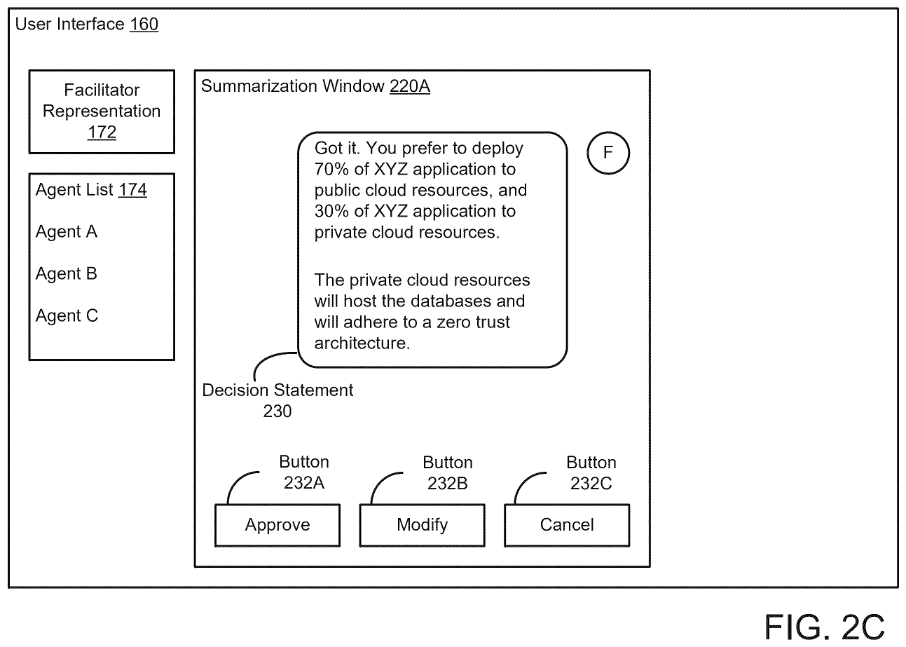

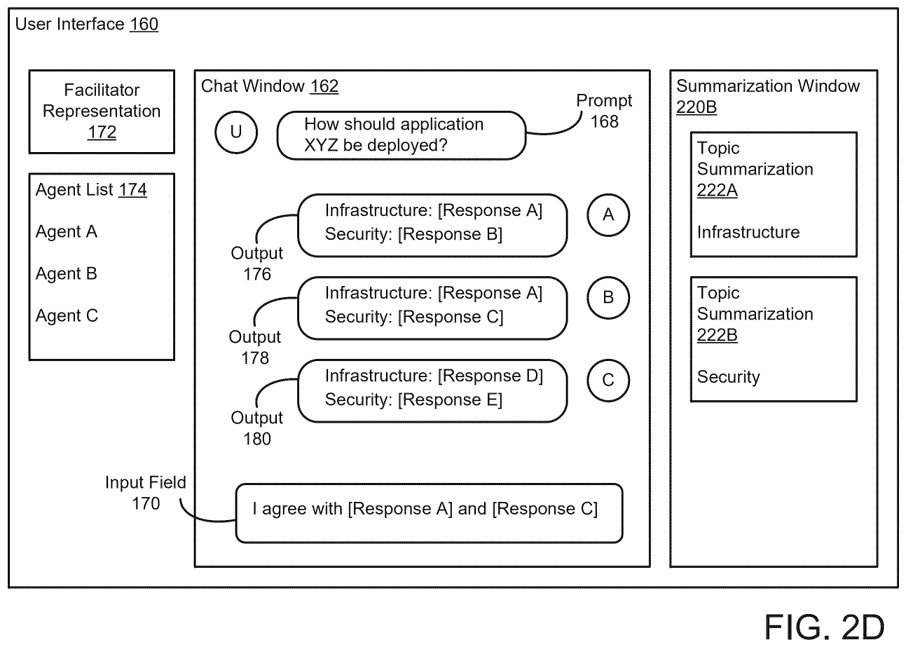

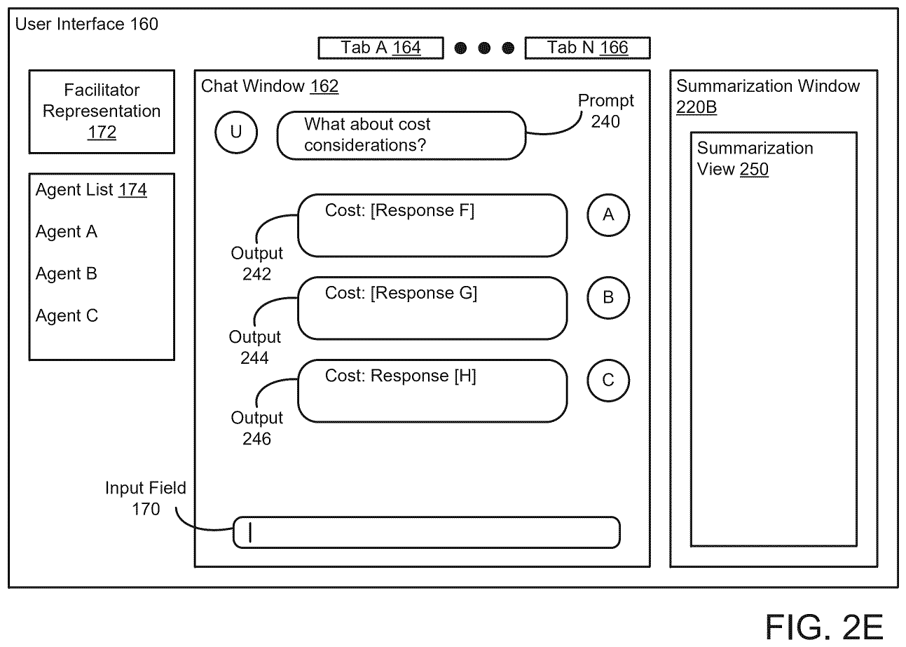

To instantiate new agentic agents, agent management process 116 may be performed. During agent management process 116, information regarding domains of expertise for an agent may be obtained. The identified domains may be used to discriminate relevant information from agent assets 120. Agent assets 120 may include any type and quantity of information usable to customize an agentic agent for a particular domain. Once obtained, the agentic agent may be customized for the domain (e.g., type of environment in which infrastructure that will be managed by the agent will reside, the particular goal or competency that the agent is desired to have, etc.) and then deployed. Refer to FIGS. 1C and 2A-2B for additional information regarding customization of agentic agents for domains.

The resulting agentic agents (e.g., agentic agents 118) may be customized for different operating environments such as, for example, a data center environment; a telecommunications computing environment; an edge computing environment; a cloud computing environment; a backup computing environment; an artificial intelligence environment; a co-located computing environment; and a storage computing environment. The agentic agents may also be customized for different domains of expertise of capabilities such as, for example, security; performance; data protection; resource management; health; and sustainability.

To perform the customization, agent assets 120 may include various types of information usable to customize the operation of, for example, generative artificial intelligence processes performed by, for example, large language models or other types of generative inferencing models used by the agentic agents. For example, agent assets 120 may include documentation for the infrastructure, software hosted by the infrastructure, testing performed for the infrastructure, support tickets for the infrastructure and corresponding resolution processes performed to address the issued indicated by the support tickets, telemetry data for operation of the infrastructure (and/or simulations of the infrastructure, such as digital twins), logs of operation of the infrastructure, etc.

The content of agent assets 120 may be pre-segmented or dynamically segmented with respect to the different domains (e.g., computing environment, competency/concern, etc.) to which the agentic agents may be customized. The content may be segmented with respect to relevancy for these different domains. The segmentation may be performed via any method. For example, a large language model may be used to process different portions of the content and classify it with respect to levels of relevancy, natural language processing and grading rubrics for relevancy may be used, subject matter experts may segment it, etc.

During the performance of interface process 112, information regarding the chat session may be stored in interaction history 114. The information may be used, for example, to document tacit statements made by the users. The tacit statements may be subsequently used to derive intents of the users, and select various management actions for performance to update the operation of managed infrastructure 102 over time. Thus, the operation of managed infrastructure 102 may be more likely to be aligned with the intents of the users and thereby provide computer implemented services that are more likely to be deemed to be desirable by the users.

Turning to FIG. 1C, a second data flow diagram in accordance with an embodiment is shown. The second data flow diagram may illustrate data used in and data processing performed in operation of agentic agents deployed in the system of FIG. 1A.

During operation, agentic agents may include various components that facilitate autonomy and decision making to manage various aspects of the operation of managed infrastructure. For example, an agentic agent may include tool layers that facilitate access and use of external entities to obtain information and drive external processes, reasoning layers to analyze the obtained information using, for example, large language models or other types of generative trained machine learning models, action layers to facilitate interactions between the agentic agents and external entities, and/or other layers.

To implement a tool layer, agentic agent 140 may perform perception process 142. During perception process 142, various types of data may be obtained from remote entities. The data may include, for example, information regarding the state of managed infrastructure, information from other agentic agents, communications of users and/or other entities participating in chat sessions, etc. Once obtained, the obtain data may be processed to obtain processed data 144.

To implement a reasoning layer, agentic agent 140 may perform decision making process 146. As part of decision making process 146, various reasoning algorithms from reasoning repository 150 may be performed, various portions of data may be stored in storage repository 148 for future use and existing information from storage repository 148 may be obtained, various models (e.g., large/small language models) from model repository 149 may be used, and/or other processes may be performed.

For example, a reasoning algorithm such as chain of thought from reasoning repository 150 may be performed. As part of the reasoning algorithm, various calls may be made to the language models from model repository 149 may be made to process various portions of processed data 144 (e.g., which may include text from a chat session, may be used as a prompt). The language models, in turn, may make various calls to data structures stored in storage repository 148 operating as pre-inference information retrieval sources for retrieval augmented generation (RAG). The resulting inferences from the language models may be used to drive the operation of the reasoning model to obtain various outcomes and store various portions of information in storage repository 148 for future use.

To implement an action layer, agentic agent 140 may perform response performance process 152. During response performance process 152, the outcomes obtained from the reasoning process may be used to invoke functionality of various other entities such as to, for example, send responses to chat sessions and modify the operation of the managed infrastructure. For example, when participating in a chat session, text from a user may be processed as a prompt by the agentic agent which may in turn generate a client response and/or initiate performance of an infrastructure command to modify the operation of the managed infrastructure. The infrastructure command may be processed by an automation framework of the managed system, and cause corresponding actions to be performed by the managed infrastructure. For example, the infrastructure command may be to change a configuration setting, remove/add/modify software, disable/enable various hardware components, etc.

Turning to FIG. 1D, a third data flow diagram in accordance with an embodiment is shown. The third data flow diagram may illustrate data used in and data processing performed in chat sessions used to manage the managed infrastructure.

When a client process reaches out to the management system, an agent management process (e.g., 190) may be performed. During the agent management process, a chat session may be initiated to facilitate interactions between users and agentic agents that manage portions of managed infrastructure.

It will be appreciated that the chat session may include various exchanges and storages of information temporally over time between various participants of the chat session. To facilitate understanding of the chat session, a user interface (e.g., 160) may be presented to a user participating in the chat session. User interface 160 may be a graphical user interface usable to represent how the user and other entities are participating in the chat session. User interface 160 may include, for example, tabs (e.g., 164-166), chat window 162, facilitator representation 172, and agent list 174. Each of these components is discussed below.

Tabs 164-166 may be graphical representations of different chat sessions that the user is participating in at any point in time. For example, during a duration of a chat session, a tab may exist. To page through the different chat session, the user may select corresponding ones of the tabs. When so selected, chat window 162, facilitator representation 172 and agent list 174 may be updated to reflect the chat session selected by the user.

Chat window 162 may be a graphical representation of contributions to a chat discussion made by the user and other entities. For example, chat window may include an input field (e.g., 170) through which the user may provide user input. The user input may be treated, for example, as prompt (e.g., 168) or other type of statement for processing.

For example, when a chat session is initially established, the user may enter text which may be processed as a prompt to attempt to identify agentic agents to participate in the chat session. In the context of a prompt such as “How should application XYZ be deployed”, the prompt may be processed using a large language model (or other type of analysis) to identify which agentic agents are likely to positively contribute to a discussion regarding the prompt (e.g., in the context of the managed infrastructure). The aforementioned prompt may result in the identification that new agentic agents should be instantiated due to the domains indicated by the prompt, and identification of existing agentic agents that are to participate in the discussion (e.g., on the basis of relevancy to the domains). As noted above, each customized agentic agent may be customized for a subset of domains (e.g., computing environment, competency, etc.).

Thus, prompt 168 may be processed by agent management process 190 which may in turn instantiate and/or connect various agentic agents to the chat session.

To inform the user of participants in the discussion, facilitator representation 172 may be graphical representation of a facilitator (e.g., an agentic agent, or other type of computerized entity) participating/guiding the discussion.

Likewise, to inform the user of the agentic agents, agent list 174 may include representations of the agentic agents that are participating in the discussion. In the example illustrated in FIG. 1D, no representations are included in agent list 174 because no agentic agents have joined the chat session.

Turning to FIG. 1E, a fourth data flow diagram in accordance with an embodiment is shown. The fourth data flow diagram may illustrate data used in and data processing performed in chat sessions used to manage the managed infrastructure.

Once agentic agents have joined the chat session, as shown in FIG. 1E, identities/representations of the agentic agents may be added to agent list 174. In this example, Agent A, Agent B, and Agent C are used. However, it will be appreciated that icons or other types of graphical elements may be used to convey to the user which agents are participating in the chat session.

Turning to FIG. 1F, a fifth data flow diagram in accordance with an embodiment is shown. The fifth data flow diagram may illustrate data used in and data processing performed in chat sessions used to manage the managed infrastructure.

Once agentic agents have joined the chat session, the agentic agents may independently and/or in cooperation participate in the chat session by, for example, generating output (e.g., 176-180) based on portions of the chat. The agentic agents may do so, for example, using their reasoning logic and language models. The output may be of any type and form. However, as discussed above, each of the agents may be customized for different domains. Consequently, the content of the responses generated by the respective agents may be different and aligned with the respective competency domains of the respective agents.

The chat session may then progress with the user adding addition information via input field 170 to the chat and the agentic agents participating in the chat generating corresponding responses.

Overtime, the agentic agents may process the chat to generate proposed tacit statements regarding an intent of the user. These statements may be presented as an output to the user, and the user may confirm, modify, or deny acceptability of the tacit statements. To generate a proposed tacit statement, feedback from the user may be obtained. The feedback may be solicited from the user using summarizations of at least a portion of the conversation to improve a likelihood that the tacit statement indicates desired intent of the user. Refer to FIGS. 2A-2E for additional details regarding using the summarizations of the conversation to generate tacit statements.

When a tacit statement is confirmed, the confirmed tacit statement may be stored as part of the corpus of knowledge used to infer the intent of the user. The agentic agents may then act on the inferred intent of the user, as discussed above.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 2A, an example user interface is shown. As previously discussed in FIGS. 1D-1F, a user may participate in a chat session (e.g., conversation) using chat window 162 of user interface 160, a prompt may be issued by the user, agentic agents may join the chat session, outputs (e.g., 176-180) may be generated by the agentic agents, and/or any other processes may be performed.

For example, consider a scenario (shown in FIG. 2A) where the user issues a prompt “How should application XYZ be deployed?” to chat window 162. Agent A, agent B, and agent C may be added to the conversation. Agent A may be a representation of software architect. Agent B may be a representation of a development and operations engineer. Agent C may be a representation of a business manager. As such, each of the agentic agents in the conversation may be trained using different data sets for their respective domains and may subsequently present different viewpoints with respect to responses to the prompt.

Agent A may provide output 176 that may include, for example, text stating: “I would allocate 30% of our deployment to private cloud resources, focusing on workloads that require higher levels of data privacy, compliance, and integration with existing on-premises infrastructure. I would allocate 70% of our deployment to public cloud resources and utilize cloud microservices. I would implement a zero-trust architecture that enforces continuous monitoring to enforce strict identify verifications. This strategy would optimize resource allocation, enhance disaster recovery capabilities, and security”.

Agent B may provide output 178 that may include, for example, text stating: “I would allocate 30% of our deployment to private cloud resources, focusing on customer sensitive information to maintaining stricter control over our data environment. I would allocate 70% of our deployment to public cloud resources that have native integrations with our existing infrastructure to be implemented in our continuous integration and continuous deployment pipelines. I would implement a layered security approach that includes network security, application security, and data security measures. This strategy would maintain a secure and agile infrastructure.”

While shown in FIGS. 2A-2B as the same response (e.g., response A) between agent A and agent B, it will be appreciated that output 176 and output 178 may include similar but different responses with respect to a topic of the conversation.

Agent C may provide output 180 that may include, for example, text stating: “I would allocate 60% of our deployment to private cloud resources, to capitalize on our existing private cloud resources. I would allocate 40% of our deployment to public cloud resources, for applications that require broader geographic reach. I would leverage built-in security tools and prioritize security measure based on risk levels and compliance requirements. This strategy would ensure compliance with regulations and take advantage of existing resources.”

However, a likelihood that user feedback may be obtained to understand an intent of the user may be negatively impacted if the user is unable to make decisions using the outputs of the agentic agents. For example, the user may be unable to make a decision regarding management of the infrastructure if the outputs include contrasting information, a volume of content of the outputs overwhelms a capacity of the user to process the information, topics of the conversation are fragmented, and/or any other conditions may negatively impact an ability to receive feedback from the user to obtain an understanding of the intent of the user.

Thus, to improve a likelihood that feedback may be obtained from the user for understanding the intent of the user, at least a portion of the outputs may be summarized to solicit the feedback from the user. To initiate the summarization, user input may be obtained that indicates a request by the user to receive the summarization. For example, button 200 may be selected (e.g., clicked) to change a mode of the chat interface to a summarization mode. Refer to FIGS. 2B-2D for additional details regarding using the summarization to solicit user feedback.

The summarization may also be generated and/or provided, for example, via a summarization view that may be displayed concurrently with the chat window 162 (e.g., without changing a mode of the chat interface). Refer to FIG. 2E for additional information regarding summarizing a current view of the chat interface.

Turning to FIG. 2B, a mode of the conversation from FIG. 2A is changed to a summarization mode. While in the summarization mode, summarization window 220A is shown. Summarization window 220A may include, for example, topic summarizations (e.g., 222A-222B), range elements (e.g., 224A-224B), button 226, and/or any other elements. Summarization window 220A may be displayed, for example, by replacing chat window 162 (from FIG. 1A). Button 228 may be included, for example, to change to a conversation mode (e.g., returning to chat window 162) upon selection.

The topic summarizations (222A, 222B, etc.) may include generated summarizations based at least on the outputs/responses of agentic agents during the conversion (e.g., outputs 176-180 discussed in FIG. 2A). Each topic summarization may be generated, for example, using a large language model and a prompt indicating a request to summarize at least a portion of a response of an agentic agent. For example, topic summarization 222A may include a summarization of a topic of infrastructure while topic summarization 222B includes a summarization of a topic of security as discussed by the agentic agents. The topic summarization may, for example, present information in a manner (e.g., more organized and/or concise compared to outputs 176-180) that may be more likely to be usable to the user.

Furthermore, range elements (e.g., 224A-224B) may indicate different viewpoints (e.g., content of responses, approaches, etc.) based on the responses of the agentic agents. A range element may include, for example, a range slider user interface element (shown in FIG. 2B) that indicates the different viewpoints along a continuous scale and allows the user to select a value along the continuous scale to indicate relative agreement with a viewpoint with respect to a topic. The viewpoints may, for example, be qualitative and/or quantitative when positioned on the range element.

For example, range element 224A may include response A (e.g., “30% private cloud resources and 70% public cloud resources) and response D (e.g., “70% private cloud resources and 30% public cloud resources) indicated on the continuous scale using indicator markers (shown using inverted triangles in FIG. 2B). The user may use a selector (shown using a circle on the range element in FIG. 2B) to provide feedback indicating relative agreement with response A. Feedback may similarly be obtained regarding other topics identified in the conversation using the other topic summarization (e.g., security in topic summarization 222B) and range elements (e.g., 224B). Once selected, user input may be obtained, for example, to confirm the feedback by clicking button 226.

Turning to FIG. 2C, a decision statement (e.g., a tacit statement indicating a partial but incomplete statement of intent of the user) may be obtained based on the feedback from the user.

For example, based on the user feedback (e.g., provided using range elements in FIG. 2B, user input in FIG. 2D, etc.), decision statement 230 may be generated to acknowledge an intent of the user. Decision statement 230 may be generated, for example, by aggregating portions of user feedback to generate the tacit statement. For example, based on the user selections using the range elements in FIG. 2B, decision statement 230 may be generated and may include the text: “Got it. You prefer to deploy 70% of XYZ application to public cloud resources, and 30% of XYZ application to private cloud resources. The private cloud resources will host the databases and will adhere to a zero-trust architecture.”.

User input may subsequently be obtained regarding whether the user desires to confirm, modify, or deny acceptability of decision statement 230 using button 232A, button 232B, or button 232C, respectively. When decision statement 230 is confirmed, decision statement 230 may be stored as part of the corpus of knowledge used to infer the intent of the user.

Turning to FIG. 2D, summarization of the conversation may be generated and presented to the user using summarization window 220B following selection of the summarization mode via button 200 in FIG. 2A. Interactions shown in FIG. 2D may be, for example, an alternative to interactions shown in FIG. 2B to obtain user feedback using summarizations.

Summarization window 220B may be displayed along with chat window 162 to provide summarization of outputs (176-180) of the agentic agents, similarly to summarizations described in FIG. 2B. By doing so, topic summarizations (e.g., 222A-222B) may be used by the user along with contents of chat window 162 while providing feedback.

The feedback may be provided by the user using input field 170. For example, the user may input text that includes “I agree with deploying an infrastructure that includes 30% private cloud resources and 70% public cloud resources. I also agree with implementing a zero-trust architecture.”. A tacit statement may subsequently be generated based on the user input that may be confirmed, modified, or denied by the user similar to shown in FIG. 2C.

Turning to FIG. 2E, a summarization may be generated for at least a portion of the conversation over time. The summarization may be generated, for example, for a current view of chat window 162 (e.g., via a running process to summarize content of the current view)

For example, in FIG. 2E, a new prompt (e.g., 240) may be issued by the user that may include: “What about cost considerations?”. Each of agent A, agent B, and agent C (e.g., agentic agents that may include representations similar to representations discussed in FIG. 2A) may provide an output (e.g., 242-246) based on prompt 240.

Agent A may provide output 242 that may include, for example, text stating: “Based on our anticipated usage patterns for application XYZ, we will require compute and storage resources of the public cloud that will range from $15,000-$20,000 monthly, analytics tools that will cost about $5,000 monthly, hardware component upgrades will cost $30,000 and will improve performance by 15%, etc.”.

Agent B may provide output 244 that may include, for example, text stating: “We will require integration software with license fees being around $10,000 annually, maintenance for hardware components can stabilized to be around $1,500 monthly using monitoring solutions, etc. We can utilize cost management tools that can reduce monthly costs by $6,000.”

Agent C may provide output 246 that may include, for example, text stating: “Based on our running budget of $100,000 monthly, we will need to prioritize security, agility, etc. By using existing private cloud infrastructure, we can have a more predictable monthly costs for maintenance and resource usage and avoid compliance fees for sensitive data. Due to a current state of our budget and priorities, we cannot invest in hardware component upgrades until next year.”

Summarization view 250 may included generated summarization of output 242-246 that may summarize at least a portion of content of the outputs shown in a current view of chat window 162, a disagreement between the agentic agents (e.g., a disagreement over hardware components upgrades based on cost between output 242 and output 244 in the example above), viewpoints of the agentic agents (e.g., based on the representations of the agentic agents), and/or any summarizations.

Furthermore, other portions of the conversation (e.g., previous prompts and responses not in a current view of chat window 162) may be considered (e.g., referenced) in the summarization and/or may be viewed using tabs 164-166.

By doing so, the user may be more likely to provide feedback (e.g., make a decision) regarding management of the infrastructure using the summarizations compared to only using the outputs. For example, the user may consume information provided by the summarization in a more timely manner compared to second information (e.g., that may be more verbose, detailed, fragmented, etc.) provided by the outputs.

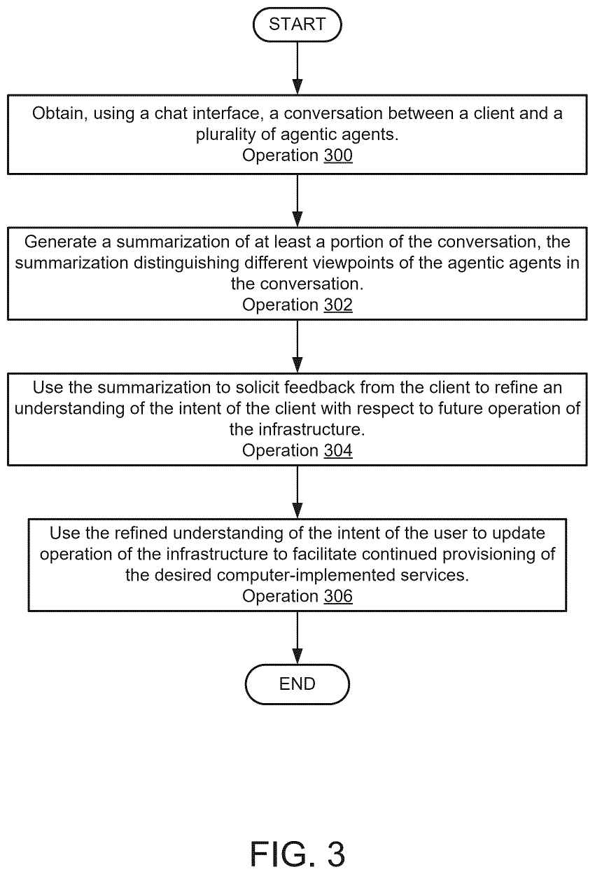

As discussed above, the components of the system shown in FIG. 1A may perform various methods to manage operation of infrastructure. FIG. 3 illustrates a method that may be performed by the components of the system of FIG. 1A. In the diagram discussed below and shown in FIG. 3, any of the operations may be repeated, performed in different orders, and/or performed in parallel with or in a partially overlapping in time manner with other operations.

Turning to FIG. 3, a first flow diagram illustrating a method for managing infrastructure using agentic agents in accordance with an embodiment is shown. The method may be performed by any of the components of FIG. 1A, and/or other entities without departing from embodiments disclosed herein.

At operation 300, a conversation between a client and plurality of agent agents may be obtained. The agentic agents may be adapted to manage the infrastructure on behalf of the client. The conversation may be obtained by: (i) initiating a conversation using a chat interface, (ii) receiving a prompt from the user using an input field to submit the prompt, (iii) identifying the agentic agents to participate in the conversation, (iv) generating responses to the prompts by each of the agentic agents, and/or via any other processes.

At operation 302, a summarization of at least a portion of the conversation may be generated. The summarization may be generated by: (i) obtaining user input indicating that the summarization is to be provided (e.g., by selecting a button to change a mode of the chat interface to a summarization mode), (ii) prompting a large language model to summarize the conversation in a certain manner (e.g., content displayed in a current view of the chat interface, disagreements between the agentic agents in the conversation, viewpoints of the agentic agents with respect to a topic, etc.), (iii) continuously generating the summarization along the chat interface while the conversation progresses in the chat interface, and/or via any other process.

At operation 304, the summarization may be used to solicit feedback from the client to refine an understanding of the intent of the client with respect to future operation of the infrastructure. The summarization may be used to solicit feedback by: (i) positioning the different viewpoints on a sliding range element, (ii) presenting the summarization of the different viewpoints, (iii) receiving the feedback using the sliding range element corresponding to relative agreement of the user with at least one viewpoint, (iv) receiving textual input from the user using an input field of the chat interface, and/or via any other processes.

At operation 306, the refined understanding of the intent of the user may be used to update operation of the infrastructure. The refined understanding of the intent of the user may be used by: (i) generating a tacit statement based on the user feedback, (ii) aggregating the tacit statement with other tacit statements derived from the client (e.g., based on previous conversations), (iii) inferring the intent of the user based on the aggregated tacit statements (e.g., using a large language model), (iv) identifying a management action based on a difference between the inferred intent of the user and a current operation of the infrastructure, and/or performing any other actions.

The method may end following operation 306.

Thus, via the method shown in FIG. 3, embodiments disclosed herein may facilitate management of infrastructure using summarizations of at least a portion of a conversation between a client and agentic agents. The summarizations may facilitate obtainment of client feedback that indicates an intent of the client with respect to operation of the infrastructure.

Embodiments disclosed herein may be implemented with one or more computing devices. Turning to FIG. 4, a block diagram illustrating an example of a data processing system (e.g., a computing device) in accordance with an embodiment is shown.

For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processors can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing infrastructure that provides desired computer implemented services, the method comprising:
obtaining, using a chat interface, a conversation between a client and a plurality of agentic agents, the agentic agents being adapted to manage the infrastructure on behalf of the client;
generating a summarization of at least a portion of the conversation, the summarization distinguishing different viewpoints of the agentic agents in the conversation;
using the summarization to solicit feedback from the client to refine an understanding of intent of the client with respect to future operation of the infrastructure; and
using the refined understanding of the intent of the client to update operation of the infrastructure to facilitate continued provisioning of the desired computer implemented services.

2. The method of claim 1, further comprising:
prior to generating the summarization:
obtaining user input from the client indicating a request to change a mode of the chat interface to a summarization mode, the user input comprising a button selection.

3. The method of claim 2, wherein using the summarization comprises:
providing, while in the summarization mode, the different viewpoints indicated using a range element; and
obtaining the feedback from the client using the range element, the feedback comprising a selection on the range element corresponding to relative agreement with one viewpoint of the different viewpoints.

4. The method of claim 1, wherein generating the summarization comprises:
summarizing at least a portion of content of the conversation, the content being the portion of the conversation displayed in a current view of the chat interface.

5. The method of claim 1, wherein generating the summarization comprises:
summarizing at least one disagreement between the agentic agents in the conversation.

6. The method of claim 1, wherein generating the summarization comprises:
summarizing the different viewpoints of the agentic agents with respect to at least one topic of the conversation.

7. The method of claim 1, wherein using the summarization comprises:
generating a tacit statement based on the feedback from the client, the tacit statement being a partial but incomplete statement of the intent of the client.

8. The method of claim 7, wherein using the refined understanding comprises:
inferring the intent of the client using, at least, the tacit statement and another tacit statement derived from the client;
identifying at least one difference between current operation of the infrastructure and the inferred intent of the client;
selecting at least one action based on the at least one different, the at least one action being selected to at least mitigate the at least one difference; and
performing the at least one action to update the operation of the infrastructure.

9. The method of claim 1, wherein the agentic agents are customized versions of trained agents, each version of the customized versions being trained using a different data set.

10. The method of claim 9, wherein the agentic agents are trained for different domains using different data sets, a viewpoint of an agentic agent of the agentic agents being based on a domain of the different domains for which the agentic agent is trained.

11. A non-transitory machine-readable medium having instructions stored therein, which when executed by a processor, cause operations for managing infrastructure that provides desired computer implemented services to be performed, the operations comprising:
obtaining, using a chat interface, a conversation between a client and a plurality of agentic agents, the agentic agents being adapted to manage the infrastructure on behalf of the client;
generating a summarization of at least a portion of the conversation, the summarization distinguishing different viewpoints of the agentic agents in the conversation;
using the summarization to solicit feedback from the client to refine an understanding of intent of the client with respect to future operation of the infrastructure; and
using the refined understanding of the intent of the client to update operation of the infrastructure to facilitate continued provisioning of the desired computer implemented services.

12. The non-transitory machine-readable medium of claim 11, wherein the operations further comprise:
prior to generating the summarization:
obtaining user input from the client indicating a request to change a mode of the chat interface to a summarization mode, the user input comprising a button selection.

13. The non-transitory machine-readable medium of claim 12, wherein using the summarization comprises:
providing, while in the summarization mode, the different viewpoints indicated using a range element; and
obtaining the feedback from the client using the range element, the feedback comprising a selection on the range element corresponding to relative agreement with one viewpoint of the different viewpoints.

14. The non-transitory machine-readable medium of claim 11, wherein generating the summarization comprises:
summarizing at least a portion of content of the conversation, the content being the portion of the conversation displayed in a current view of the chat interface.

15. The non-transitory machine-readable medium of claim 11, wherein generating the summarization comprises:
summarizing at least one disagreement between the agentic agents in the conversation.

16. A system, comprising:
a processor; and
a memory coupled to the processor to store instructions, which when executed by the processor, cause operation for managing infrastructure that provides desired computer implemented services to be performed, the operations comprising:
obtaining, using a chat interface, a conversation between a client and a plurality of agentic agents, the agentic agents being adapted to manage the infrastructure on behalf of the client;
generating a summarization of at least a portion of the conversation, the summarization distinguishing different viewpoints of the agentic agents in the conversation;
using the summarization to solicit feedback from the client to refine an understanding of intent of the client with respect to future operation of the infrastructure; and
using the refined understanding of the intent of the client to update operation of the infrastructure to facilitate continued provisioning of the desired computer implemented services.

17. The system of claim 16, wherein the operations further comprise:
prior to generating the summarization:
obtaining user input from the client indicating a request to change a mode of the chat interface to a summarization mode, the user input comprising a button selection.

18. The system of claim 17, wherein using the summarization comprises:
providing, while in the summarization mode, the different viewpoints indicated using a range element; and
obtaining the feedback from the client using the range element, the feedback comprising a selection on the range element corresponding to relative agreement with one viewpoint of the different viewpoints.

19. The system of claim 16, wherein generating the summarization comprises:
summarizing at least a portion of content of the conversation, the content being the portion of the conversation displayed in a current view of the chat interface.

20. The system of claim 16, wherein generating the summarization comprises:
summarizing at least one disagreement between the agentic agents in the conversation.
